(19) United States
(12) Patent Application Publication
(10) Pub. No.: US 2008/0314186 A1
(43) Pub. Date: Dec. 25, 2008

(54) Shifter Lever Knob Adapter and Kit Including Same

(76) Inventor: Kevin S. Ford, Knoxville, TN (US)

Correspondence Address: PITTS AND BRITTIAN P C, P O BOX 51295, KNOXVILLE, TN, 37950-1295, US

(21) Appl. No.: 11/766,454

(22) Filed: Jun. 21, 2007

(51) Int. Cl. B60K 20/00

(52) U.S. Cl. 74/473.23

(57) ABSTRACT

A multi-component adapter, available in a kit, which permits the use of “non-button” knobs on existing shifter levers which are originally intended to be operative only in combination with a button-containing knob. In one embodiment, the present multi-part adapter comprises a generally hollow cylindrical body member adapted to be mounted on the outboard distal end of an existing shifter lever without modification of the shifter lever, a hollow internally threaded cylindrical sleeve threadably mounted on the outboard distal end of the shifter lever and slidably received with a bore in a first end of the body member functioning to affix the body member to the outboard distal end of the shifter while providing for limited linear movement of the body member relative to the shifter lever, and an externally threaded nipple adapted to be received within a bore in a second end of the body member and further adapted to mount a non-button type knob on the outboard end of the body member.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to motor vehicles having a shifter lever for selecting the gearing of the output shaft of the engine to the drive shaft for the drive wheel(s) of the vehicle. More particularly, this invention relates to knobs affixed to that outboard end of the shifter lever which is normally grasped by a driver for “shifting gears” in a motor vehicle.

### BACKGROUND OF THE INVENTION

Motor vehicles, such as trucks, passenger automobiles, buses and the like commonly include a means for selecting an appropriate combination of gears, or a flow pattern of the transmission fluid of an fluid drive, contained within a transmission and which are disposed intermediate the vehicle engine and the vehicle drive shaft leading to the driving wheels of the vehicle. Also commonly, this means includes a lever leading from the transmission of the vehicle upwardly and into the interior of the vehicle, such lever terminating at a location convenient to the driver of the vehicle for use in selection of the “gears” of the vehicle. This lever may be at times referred to as a “shifter” where the term is generally intended to include the shifter lever, its various components and the gear disposed within the transmission, as the context requires. Also, herein, the terms “gears”, “gearing” and “shifting gears” are intended to include actual mechanical gears and/or fluid drive transmissions unless the context indicates otherwise, inasmuch as the present invention is independent of the type of transmission involved.

For ease of grasping of the shifter lever by a driver, the outboard distal end of the shifter lever is commonly fitted with a knob which is geometrically comfortable and readily tactilely identifiable to the driver. Commonly, this knob is threaded onto the outboard end of the shifter lever.

As is well known in the art, different gearing combinations are referred to as “park”, “reverse”, “neutral”, “drive”, “third”, “second” and “first”, or some similar combination or variation of these combinations. “Shifting” of gears has come to refer to the act of selecting the desired gearing combination.

As a safety factor, commonly modern gear shifting includes some means for “locking” of the means employed to select a desired combination of gears so that the gearing combination cannot inadvertently be changed. For example commonly, the gears of a motor vehicle can not be shifted from “drive” to “reverse” without first “unlocking” of the shifter lever. Whereas certain vehicles are equipped to permit shifting between gear combinations as a function of the speed of movement of the vehicle (motor torque or other operational factor), in other vehicles, such as racing cars, unlocking of a gear combination desirably is selectable at the discretion of the driver of the vehicle, irrespective of the operational status of the engine or the vehicle.

In the prior art, it has been the practice to include on or associated with the shifter lever some means available to the driver for manually “unlocking” the shifter lever and selecting a different gear combination. For example, in trucks, it has been the practice to provide a relatively small lever associated with the shifter lever, such small lever being mechanically connected to the locking mechanism for the shifting lever. In this system, manual unlocking of the shifting lever for changing gears may be effected by the driver through operation of the small lever. In more modern vehicles, it has been the practice to employ a hollow rigid elongated cylindrical shifter lever and to incorporate within the shifter lever a flexible rod or cable internally of the shifter lever, such as a substantially non-compressible cable, which is slidable within the hollow shifter lever. Linear movement of this internal actuator within the hollow shifter lever is by means of a “push button” associated with the knob. The inboard end of this internal actuator is operatively connected to the locking mechanism associated with the shift lever which may be biased, as by an appropriate spring, for example, toward a position of locking the movement of the shift lever. In the prior art, movement of the internal actuator inwardly toward an “unlocking” position has been effected by including within a knob affixed to the outboard distal end of the shifter lever, a push button. Depression of such push button functions to move the internal actuator which is encased within the hollow shifter lever, in a direction suitable to unlock the shift lever for changing of the gear combination. This push button feature requires the presence of a button associated with the knob and which is readily accessible to the driver. Moreover, in the prior art, only those knobs which include a button mechanism may be employed on the outboard distal end of these prior art shifters. In certain instances, drivers may wish to “personalize” the knob as by giving it a geometrical design as opposed to the more common bulbar knob. Often these personalized knobs prevent access to the button of the knob on the distal end of an existing shifter lever. Further, some drivers, by personal choice, do not which to use a button.

These factors preclude the driver from purchasing or making and using a “non-button” knob on their vehicle shifter lever, thereby limiting the choice of knobs available to the driver, which in turn, may lessen the opportunity of different competing vehicle parts manufacturers to sell knobs which do not include a button, or which may not be fully integrated with the distal end of an existing shifter lever by reason of the knob not being able to operatively engage the internal actuator disposed within the existing shifter lever.

### SUMMARY OF PRESENT INVENTION

In accordance with one aspect of the present invention there is provided a multi-component adapter, preferably in a kit, which permits the use of “non-button” knobs on existing shifter levers which are originally intended to be operative only in combination with a button-containing knob. In one embodiment, the present multi-component adapter comprises a generally hollow cylindrical body member adapted to be mounted on the outboard distal end of an existing shifter lever without physical modification of the shifter lever, a hollow internally threaded cylindrical sleeve threadably mounted on the outboard distal end of the shifter lever and slidably received with a bore in a first end of the body member functions to affix the body member to the outboard distal end of the shifter lever while providing for limited linear and/or rotational movement of the body member relative to the shifter lever, and an externally threaded nipple adapted to be received within a bore in a second end of the body member and to mount a non-button type knob on the outboard end of the body member.

The internal threads of the sleeve are adapted to receive therein the existing externally threaded end of an existing shifter lever. Optionally, a lock nut may be included for locking the sleeve against rotation once it is threaded on the distal end of the shifter lever. In one embodiment, limited linear movement of the sleeve within the bore of the body member may be by a set screw or the like cooperatively functioning with at least one elongated narrow flat groove defined in the outer surface of the sleeve.

In use, the multiple components of the adapter of the present invention are provided to the market in kit form, each kit including all of the components to adapt a shifter from a “button” type knob to a “non-button” type knob without alteration of the outboard distal end of an existing shifter lever. If desired, the non-button knob may subsequently be removed and a conventional button-type knob may be mounted on the shifter lever.

### BRIEF DESCRIPTION OF THE DRAWINGS

FIG. 1 is a representation, in exploded view, of a prior art button-type knob attached to a shifter lever;

FIG. 2 is a sectional view of a portion of the shifter lever and adapter depicted in FIG. 1 and taken generally along line 2-3 of FIG. 1;

FIG. 3 is representation of a portion of a shifter lever embodying various aspects of the present invention, including an adapter;

FIG. 4 is a sectional view, partly exploded, depicting various components of the adapter of the present invention incorporated into a shifter lever;

FIG. 5 is an exploded view depicting various elements of an adapter of the present invention;

FIG. 6 is a sectional view of the sleeve depicted in FIG. 5 and taken generally along line 6-6 of FIG. 5;

FIG. 7 is a sectional view of the sleeve depicted in FIG. 4 and taken generally along line 7-7 of FIG. 5;

FIG. 8 is a side view of the sleeve depicted in FIG. 5; and,

FIG. 9 is a representation of a packaged kit which incorporates therein multiple components of the present adapter.

### DETAILED DESCRIPTION OF THE INVENTION

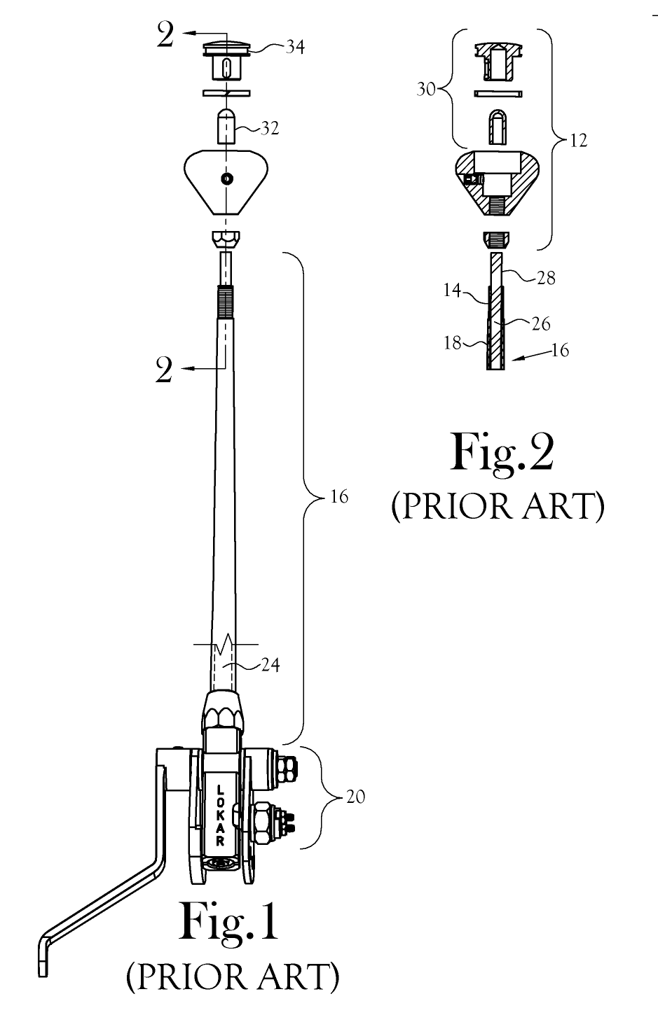

Referring initially to FIG. 1 there is depicted a typical prior art button-type knob 12 threadably affixed onto the externally threaded outboard distal end 14 of a shifter lever 16. In the depicted knob, the shifter lever is depicted as comprising a hollow cylindrical tube 18 suitable for interconnection with a locking mechanism 20 which operatively connects the inboard end 22 of the shifter lever with the transmission system as is conventional in the prior art. Internally of the hollow tube there is provided a flexible, substantially non-compressible internal actuator 22 in the form of a non-compressible cable 26 which is slidable within the hollow tube and which has its inboard end 24 operatively connected to the mechanism 20 employed for locking of the shifter lever in selected positions as is well known in the art.

The opposite end 28 of the cable projects outwardly from the outboard end of the hollow shifter lever in position to be engaged by a button mechanism 30 located internally of the knob, but operatively accessed from the exterior of the knob. The button mechanism includes a rigid connector 32 disposed between the outboard end of the actuator and the button 34 so that upon the application of pressure against the button, the actuator is pushed inwardly toward the shifter lever locking mechanism. So long as the actuator is pressed inwardly (employing the button of the knob), the gear-shifting system of the vehicle is “unlocked” so that the shifter lever may be employed to select a desired combination of gears within the transmission. Once the selection has been made, the pressure on the button is released so that the cable functions to “lock in” the newly selected combination of gears by locking the position of the shift lever. From FIG. 1, it will be recognized that the button within the knob must be readily accessible to the vehicle driver for purposes of shifting gears. Commonly, the actuator is biased toward a position wherein the shifter lever is locked.

As noted hereinabove, it is desired that the shifter lever accept knobs which exhibit a geometry which may physically block access to the button.

In accordance with one aspect of the present invention, and referring to FIGS. 2-4, the present invention includes an adapter 40 by means of which one can adapt a shifter lever 42 employing a “button” type knob to accept a knob which provides for locking and unlocking of the shifter lever of the vehicle without the need of a button, per se, and without physical modification of the existing shifter lever.

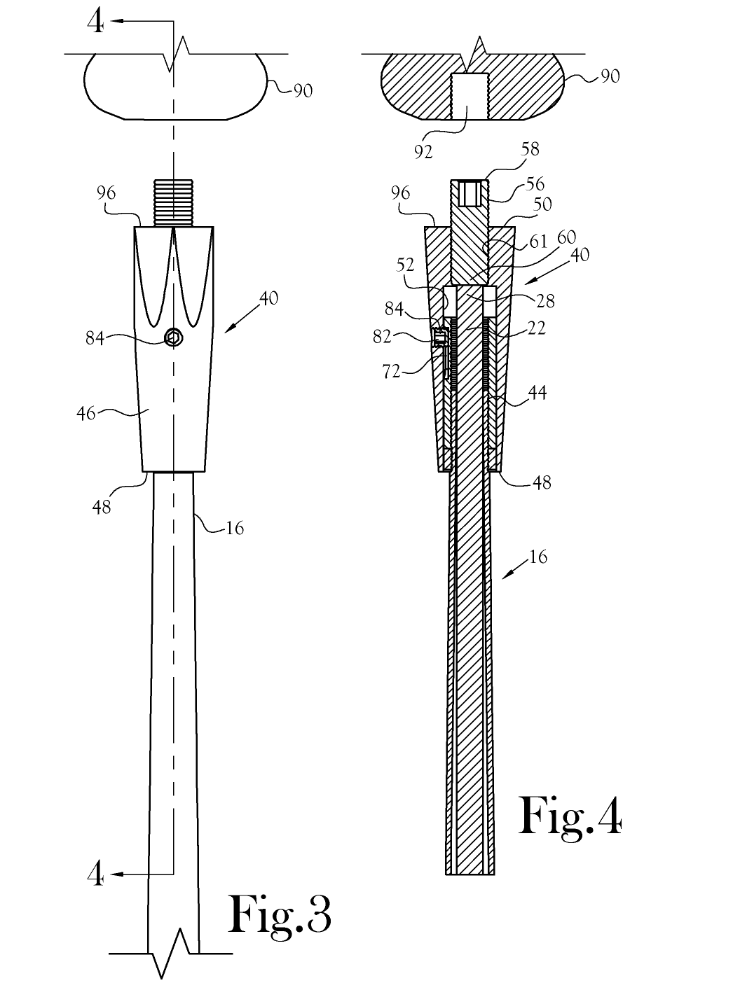

In the embodiment depicted in FIGS. 3-8, there is depicted one embodiment of a non-button, multi-component adapter which is mountable on the outboard distal end 44 of an existing shifter lever 16 without physical modification of the shifter lever itself.

Specifically, as depicted in this embodiment of the adapter of the present invention, there is provided a generally cylindrical hollow body member 46 having open opposite first and second ends 48 and 50, respectively. In the depicted embodiment, this body member is of a generally truncated conical geometry. A bore 52 is defined in the smaller diameter first end 48 of the body member and opens outwardly of the body member. The larger diameter and opposite second end 50 of the body member is provided with internal threads 52 suitable to threadably receive therein one end 54 of an externally threaded 62 nipple 56 having opposite first and second ends 58 and 60, respectively.

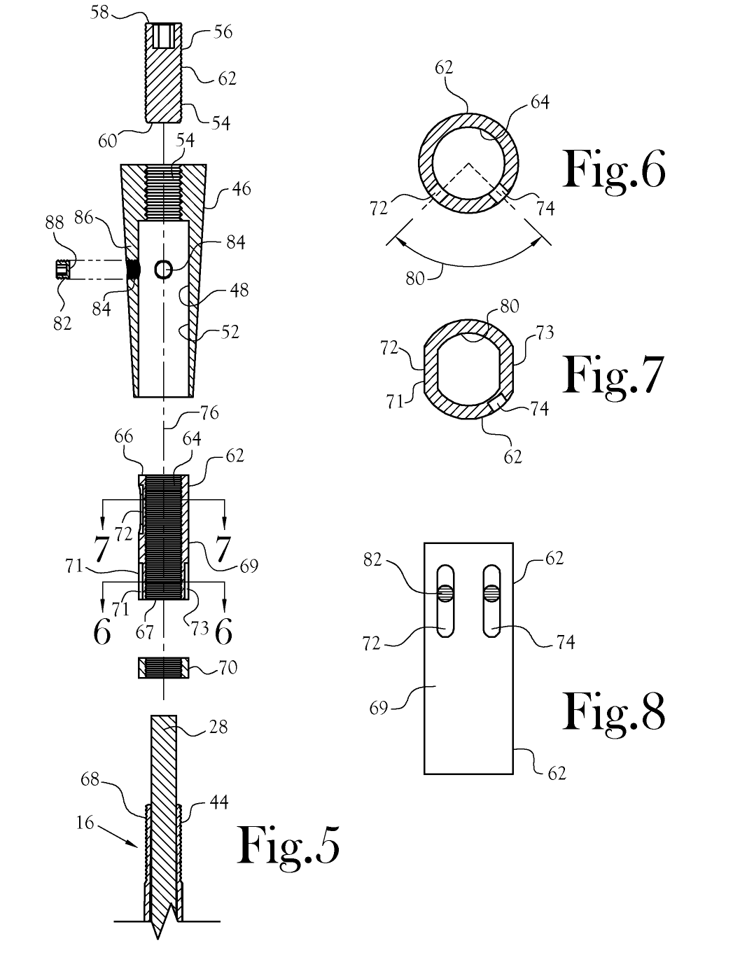

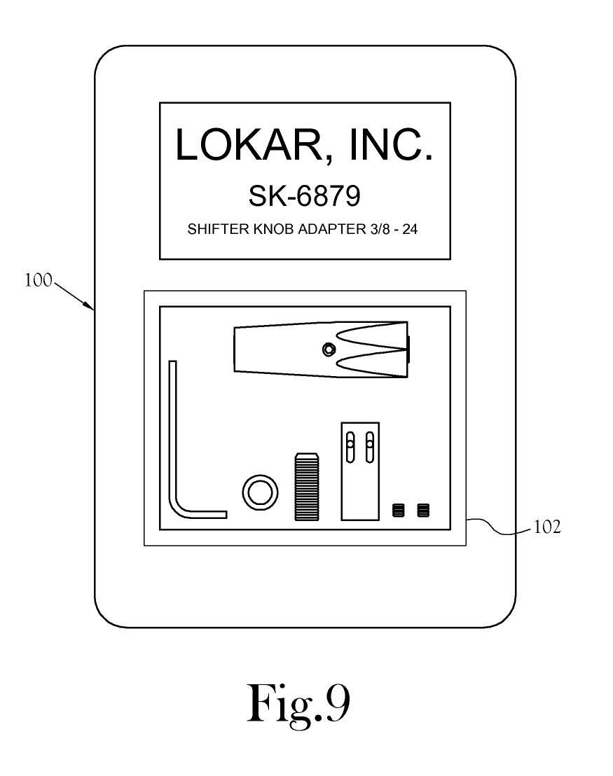

In the depicted adapter of the present invention there is provided a tubular sleeve 62 having internal threads. A first end 66 of the sleeve is threadable onto a set of external threads 68 on the outboard end 44 of the tubular shifter lever (these being the same threads employed for threadably mounting a button-type knob onto the shifter lever). In the depicted embodiment, there is provided a jam nut 70 which is threaded onto the threaded distal end of the shifter lever, followed by threading of the first end 66 of the sleeve onto the threaded distal end of the shifter lever. After the sleeve is threaded onto the distal end of the shifter lever until the sleeve “bottoms out” against the jam nut, the sleeve is “backed off” from the jam nut and the jam nut is run up against the second end 67 of the sleeve and tightened to preclude further rotation of the sleeve relative to the shifter lever. As seen in FIGS. 5 and 7, the second end 67 of the sleeve is provided with flats 71 and 73 on opposite sides of the sleeve to accept a wrench or like instrument as an aid to tightening of the jam nut against the end of the sleeve. As so mounted, the sleeve is fully slidably received within the inner bore of the first end of the body member, and is mounted for limited linear and/or rotational sliding movement within the bore. To establish the limitation on the linear movement of the sleeve within the body member, the sleeve, at respective locations along the outer surface of the sleeve, is provided with at least one and preferably two elongated grooves 72, 74 which extend substantially parallel to the longitudinal centerline 76 of the sleeve. Each groove in the depicted embodiment is of a depth less than the wall thickness of the sleeve proximate the groove. Each groove includes an inboard end 78 which originates at a location proximate, but spaced inwardly of the second end 60 of the sleeve and along the length of the sleeve a relatively short distance. The groove continues in a direction parallel to the length of the sleeve a distance which is determined as a function of the desired permissible linear movement of the sleeve within the body member. When two or more grooves are employed, they are substantially identical one with the other, extend parallel to the longitudinal centerline of the sleeve and to each other, but are spaced apart from one another about the outer circumference of the sleeve along respective radii. The angle 80 formed between these radii may vary substantially, e.g., from about 15 degrees to about 340 degrees.

At least one externally threaded cam rod 82 per each groove is mounted in an internally threaded throughbore 84 provided through the wall 86 of the body member at a location suitable for the cam rod to be threaded within the throughbore and for the leading end 88 of the cam rod to be positioned within a respective groove 72. The threaded cam rod is adjusted to non-locking, but slidable, engagement with its respective groove so that linear reciprocating movement of the sleeve within the bore of the body member is limited to substantially the length of its respective groove. Further, the outer diameter of the cam rod is chosen to be substantially equal to the width of its respective groove so that the presence of the cam rod in its respective groove inhibits rotational movement of the sleeve while permitting the desired limited linear movement of the sleeve, within the bore. In the instance where more that one groove is employed, there is provided a like threaded cam rod-to-groove relationship, thereby multiplying the restraint available for restricting the linear and/or rotational movement of the sleeve within the body member. In one embodiment, the bore exhibits a relatively smooth surface thereby enhancing the limited linear sliding movement of the sleeve within the bore. In the depicted embodiment, the threaded cam rod is depicted as a set screw, but one skilled in the art will readily recognize equivalent means for interconnecting the body member with the sleeve. One such means may include a spring-biased lug passing through the wall of the body member to engage the open-face groove in the outer wall of the sleeve.

Whereas other modes may be employed to limit the linear and/or rotational movement of the sleeve within the body member, it will be recognized that whatever mode is employed, essentially no rotational movement of the sleeve is desirable. On the other hand, the length of each groove is to be chosen as a function of the range of the linear motion of the actuator disposed within the shifter lever that is required to lock or unlock the locking mechanism of the shifter lever of the motor vehicle. This distance may differ for different shifter lever mechanisms, but is readily determined by merely observing the distance which the locking mechanism of the given system moves between its “locked” and “unlocked” positions and then selecting this distance as the minimum length of the elongated groove or grooves to be provided in the outer surface of the sleeve. Whereas groove length is excess of the distance between the locked and unlocked position of the shifter lever locking mechanism may be accepted, such longer grooves are unneeded. This factor will be more evident from the discussion hereinbelow relating to the operation of the combination of an adapter of the present invention employed to mount a non-button type knob on the outboard distal end of the shifter lever.

As seen in FIGS. 3 and 5, the present adapter includes an externally threaded nipple 56 adapted to function as the means for mounting a non-button type knob 90 onto the second end 50 of the body member 46 of the present adapter. To this end, a first end 58 of the nipple is provided with external threads 61 suitable to be received within an internally threaded bore 92 in the non-button type knob being fitted onto the shifter lever. The second end 60 of the nipple is likewise provided with external threads suitable to be received within the internally threaded end 50 of the body member.

In use, the second end 60 of the nipple is threaded partway of the length of the nipple into the second open end 50 of the body member 46. The opposite and outboard first end 58 of the nipple projects beyond the open second end 50 of the body member in position to be threadably received within the internally threaded bore (commonly a blind bore) of the non-button type knob as noted.

Accordingly, the length of the nipple is sufficient to accommodate both the internal threading of the nipple into the body member plus leaving a portion thereof projecting outwardly of the second end of the body member and thereby exposed beyond the second end of the body member for receiving a knob thereon.

Referring to FIGS. 4 and 5, internally of the body member, the inboard second end 60 of the nipple is configured to operatively engage the outboard end 28 of the substantially non-compressible actuator 22 leading from the outboard end of the shifter lever to the locking mechanism of the shifter lever.

Once the desired depth of insertion of the nipple into the body member, hence the desired engagement of the nipple with the actuator, is established, its opposite end projects outwardly from the open end of the body member in position for the threading thereupon of a knob which is provided with an internally threaded bore. The threading of the knob onto the nipple is limited by reason of the knob engaging the outermost rim 94 of the body member so that the, knob functions as a type of lock nut to secure the knob on the nipple and body member combination and restricting subsequent retraction of the nipple from its operative engagement with the outboard end of the actuator.

As seen in the FIGS. 4 and 5, the actuator 22 slidably passes into the first end of the body member, through the sleeve, and into the second end of the body member where its outboard end is engaged by the nipple. In like manner, the outer tube 18 of the shifter lever passes into the first end of the body member and into the sleeve which, in turn, is slidably mounted within the bore in the first end of the body member. However, the sleeve, being locked in position on the distal end of the shifter lever, permits the body member to move onto the outboard distal end of the shifter lever tube by the distance established by the threaded cam rod/groove arrangement referred to hereinabove. It will accordingly be recognized that the body member is slidable in a linear direction relative to the distal end of the shifter lever.

The engagement of the second end of the nipple with the outboard end of the cable is one of abutment in the depicted embodiment. The mode of engagement may, however, be a fixed or attached mode of engagement, the need being that any linear movement of the knob in a direction toward the shifter lever will result in like linear movement of the actuator within its housing in a direction toward the shifter lever locking mechanism. In as much as the knob is fixed on the nipple, hence to the outboard end of the body member, movement of the knob in a direction toward the outboard end of the actuator effects linear slidable movement of the body member relative to the sleeve which is fixedly mounted on the distal end of the shifter lever, Simultaneously, this linear movement of the body member moves the nipple linearly, thereby applying a linear force against the distal end of the actuator which moves the actuator linearly a distance sufficient to unlock the shifter lever of the vehicle. That is, the knob and body member thus function in the nature of a “button” to effect unlocking of the shifter lever. As with the “button”-type knob, release of the pressure applied to the knob releases the actuator to move away from the shifter lever locking mechanism whereupon the selected gear position becomes locked. Commonly, the locking mechanism of known shifter levers includes means for biasing the actuator toward an “unlocked” position relative to the locking mechanism.

As depicted in FIG. 8, in accordance with one aspect of the present invention, the adapter is provided in kit form, each kit 100 containing each of the components of the multi-component adapter. In the depicted embodiment, these components are packaged for ready visual inspection and laid out generally within a plane which includes the package and the actual components of the adapter. The kit further may include one or more sets of instructions 102 for disassembly of an existing “button-type” knob from a shifter lever and installation of an adapter of the present invention onto the same shifter lever without physical modification of the shifter lever. This aspect of the invention preserves the shifter lever for later removal of the “non-button” knob from the shifter lever and return or reinstallation of a “button-type” knob onto the same unmodified shifter lever.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed:

1. Apparatus for adapting a motor vehicle shifter lever having a distal outboard end and a substantially non-compressible elongated internal actuator leading to a shifter lever locking mechanism interposed between the shifter lever and the motor vehicle transmission, to accept a non-button type knob comprising
a hollow generally cylindrical body member having a first end, a second end, and a longitudinal centerline;
said first end including an internal bore aligned substantially concentric with said longitudinal centerline and opening outwardly of said body member;
said second end including a threaded portion and opening outwardly of said body member;
a hollow substantially cylindrical sleeve disposed with said bore;
said sleeve being fixedly secured to the distal outboard end of the shifter lever and adapted for slidable recipricatory movement within said bore;
the outboard distal end of the internal actuator being received internally of said sleeve with at least a portion of the internal actuator contained within the shifter lever projecting from said sleeve toward said second end of said body portion;
a nipple having a threaded first end and a threaded opposite second end;
said first end of said nipple being threadably mounted with said threaded portion of said second end of said body member with a portion thereof projecting outwardly from said body member in position to be threadably joined to a non-button type knob;
a non-button type knob threadably joined to said nipple;
said second end of said nipple being disposed in operative engagement with said outboard end of that portion of the internal actuator which projects from said sleeve;
whereby linear movement of said non-button knob in a direction toward said shifter lever effects engagement of said second end of said nipple with said outboard distal end of the internal actuator and moves said internal actuator toward a position of unlocking the locking mechanism of the shifter lever.

2. The adapter of claim 1 and including at least one elongated blind groove provided in the outer circumferential surface of said sleeve,
a throughbore extending through the wall of said body member, said throughbore being in register with said groove,
a cam rod adjustably disposed within said throughbore and terminating within said groove whereby rotation of said sleeve relative to said body member is prohibited while providing for limited linear movement of said sleeve relative to said body member.

3. The adapter of claim 2 wherein the length of said elongated blind groove is oriented substantially parallel to the longitudinal centerline of said sleeve.

4. The adapter of claim 3 wherein the length of said elongated blind groove is determined as a function of the distance the internal actuator must be moved in order to move the locking mechanism for the shifter lever of the vehicle between locked and unlocked positions.

5. The adapter of claim 1 and including means for securing said sleeve against rotation relative to said shifter lever.

6. The adapter of claim 5 wherein said means comprises a jam nut.

7. The adapter of claim 1 wherein said body member is adapted to be mounted on a shifter lever previously bearing a button-type knob, without physical modification of the shifter lever.

8. A kit for adapting a shifter lever having a button-type knob thereon for control of the locking mechanism of a shifter lever to a non-button type knob without physical modification of the shifter lever.

9. The kit of claim 8 and including a package containing an elongated generally tubular body member adapted to be interposed between the outboard distal end of the shifter lever and the non-button type knob, a nipple adapted to be interposed between, and adapted to interconnect, one end of the body member and the non-button type knob, a hollow substantially cylindrical sleeve adapted to be slidably received within that end of the body member opposite the nipple and including at least one elongated groove in the outer surface thereof, and at least one cam rod adapted to interlock the body member to the sleeve in a manner which provides for limited linear movement of the sleeve within the body member and for restriction of rotational movement of the sleeve with the body member.

10. The kit of claim 8 wherein said kit includes a hollow generally cylindrical body member having first and second opposite ends, a nipple adapted to interconnect a non-button type knob to one end of said body member, said nipple being partially disposed internally of said body member and terminating proximate an internal actuator operative for locking and unlocking the locking mechanism of the shifter lever, and partially extending externally of said body member to be joined to a non-button-type knob, a hollow sleeve slideably disposed in said body member at that end of said body member opposite said nipple, said hollow sleeve being fixedly joinable to the outboard distal end of said shifter lever and receiving an outboard distal end of said internal actuator there through with a portion of said internal actuator projecting internally of said body member and terminating in proximate operative relationship to said nipple whereby depression of said non-button knob toward said shifter lever effects engagement of said nipple with said outboard distal end of said internal actuator for effecting unlocking of said locking mechanism for said shifter lever, said inward movement of said internal actuator being limited by means of at least one elongated blind groove provided within the outer circumferential surface of said sleeve and a rod mounted in a throughbore provided through the wall of said hollow body member and extending into said groove.
